(19) United States
(12) Patent Application Publication
(10) Pub. No.: US 2006/0236575 A1
(43) Pub. Date: Oct. 26, 2006

(54) QUICK SERVICE ALERT

(76) Inventor: Mitchel B. Kaufman, APO AE 09180 (DE)

Correspondence Address: LOUIS VENTRE, JR, 2483 OAKTON HILLS DRIVE, OAKTON, VA, 22124-1530, US

(21) Appl. No.: 10/907,624

(22) Filed: Apr. 8, 2005

(51) Int. Cl. G09F 15/00

(52) U.S. Cl. 40/606.15

(57) ABSTRACT

A restaurant tabletop stand having rotatably affixed numbers and labels and a method of using the device for a silent, discrete and immediate communication between patron and a waiter to identify a specific need of the patron that matches a specific duty of the waiter.

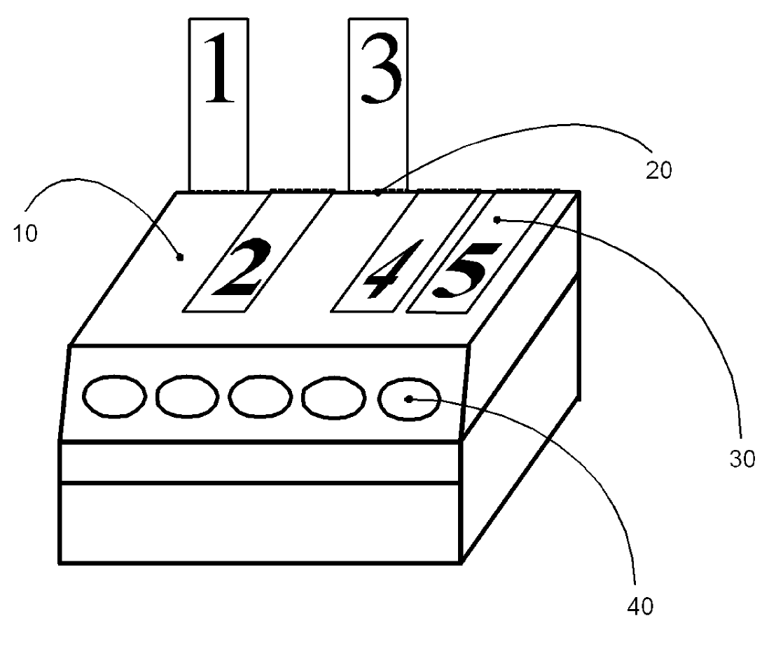

### FIELD OF THE INVENTION

The invention is a device and method to improve the overall efficiency of restaurant service and the interaction between a restaurant patron and a waiter or waitress (herein “waiter”). The device is a restaurant tabletop stand with manually displayable numbers. A restaurant patron utilizes the device to display one or more numbers and alert a waiter that a specific service is required. The numbers correspond to commonly experienced requests for service, which are identified on the stand.

### DESCRIPTION OF RELATED ART

The need for remotely communicating a restaurant patron's need for service to a waiter has been recognized in the past. The prior art concentrates on the patron activating a light or a bell or signaling with a complex radio communication device. The problem with the light and bell signal is that they do not communicate the specific patron requirement. In addition, the bell is noisy and has potential to annoy other patrons. The problem with a radio-signaling device is that it is costly, complex, noisy and prone to failures. The present invention solves these problems with a silent, simple, low cost device that is easily activated by a restaurant patron. The invention has no unattached parts that may be lost or stolen. The device is easily cleanable, requires no batteries or electricity, and requires little attention by management to maintain in working order.

The invention serves previously unaddressed needs to improve restaurant service efficiency by identifying and satisfying a patron's requirements in a minimum of waiter movements, to permit restaurant management to quickly assess the performance of wait staff as to specific patron needs, to improve the dining experience of the patron by minimizing potentially annoying waiter interruptions inquiring as to patron requirements, and to improve the patron's restaurant experience by minimizing distracting waiter traffic in the aisles. All these objects and purposes are served by the present invention. The method described below will eliminate a longer than expected waiting time due to inattentive service and will permit restaurant management to monitor the service to be attentive to patrons.

U.S. Pat. No. 5,699,039 is an example of a menu stand that is employed as a signal device to summon a waiter to a table in a restaurant or like establishment. The tabletop menu stand includes a low-energy demand light source operated by a D.C. battery and a switch activated by a restaurant patron to summon a waiter. This is an example of prior art that does not communicate the patron's specific requirement, but rather a general need requiring a waiter to visit the table and inquire as to the patron's needs. Waiter movements are not minimized, annoying foot traffic is not minimized and a positive dining experience is not as well served.

Similarly, U.S. Pat. No. 3,967,274 describes a signal light having a quick-flip switch and a light-conducting rod at the top so that when a patron of a restaurant or bar wishes immediate service the switch actuator is flipped and the light comes on to signal the desirability for service. The device comprises a tubular housing in which housing there is a spring for supporting batteries and the housing is mounted on a large circular base which may serve as an ashtray.” This is another example of a simple light system that does not communicate the patron's specific requirement, but rather a general need requiring a waiter to visit the table and inquire as to the patron's needs. Here again, waiter movements are not minimized, annoying foot traffic is not minimized and a positive dining experience is not as well served.

U.S. Pat. No. 6,831,549 is an example of an interactive network system is for communications between the restaurant service elements providing service to a customer and for recording of selected related service data. In the 549 patent, patron call units are placed on the table and communicate with the central computer and from there retransmitted to a waiter. This prior art is complex and potentially costly. It is not a system minimizing sounds and the patron is not immediately aware if his signal will be seen by a waiter.

U.S. Pat. No. 6,366,196 is an example of a waiter paging system is provided for use in a restaurant. The system includes a transmitter at each table to send a “waiter call” signal to the corresponding pager unit held by their waiter. This is an example of a wireless call system that communicates a non-specific patron requirement for service. Unlike the present invention, it does not communicate the patron's specific requirement, but rather a general need requiring a waiter to visit the table and inquire as to the patron's needs. Here again, waiter movements are not minimized, annoying foot traffic is not minimized, background sounds are not minimized, and a positive dining experience is not as well served.

U.S. Pat. No. 6,050,214 is an example of a method of alerting a waiter that the check payment of a particular kind is awaiting payment in a typical folding restaurant payment wallet. The wallet or portfolio is outfitted with one or more selectable color-coded indicators to signal, for example, cash payment, or credit card payment. The 214 patent is directed at the payment stage of the restaurant process for application in or about a payment wallet. Important distinctions between the 214 patent and the present invention are that the 214 patent is not a tabletop stand, it requires a folder with number of color-coded subsections, it requires a waiter's close proximity to observe the setting, it does not minimize waiter foot traffic and it does not use a number system.

U.S. Pat. No. 4,935,720 describes a signaling apparatus that notifies a waiter in a restaurant that a previously ordered food is available for pickup at the kitchen and can be served upon the patron. It has numbered signal lamps corresponding to the number of a table. This device is not a tabletop device used by the restaurant patron. It conveys only the immediate availability of the food for serving a particular table. While the 720 invention is used to improve service, it is not used to simply and efficiently convey a request for service from a restaurant patron. Here again, waiter movements in the service of patron requirements are not addressed, annoying waiter foot traffic is not minimized, background sounds are not minimized, management may not quickly assess the performance of wait staff beyond the initial service of the food, and a positive dining experience is not as well served.

### BRIEF SUMMARY OF THE INVENTION

The device is a restaurant tabletop stand having cards or signs that may be manually flipped up to display printed numbers. A restaurant patron utilizes the device to display one or more numbers and alert a waiter that a specific service is required. The numbers correspond to commonly experienced requests for service, which are identified on the stand. The numbered signs lie flat on the stand until the patron flips them up to a vertical position for display. In the method of the invention, a restaurant patron reads the label to identify the numbered sign corresponding to his request. The patron then rotates the sign with that number to a vertical position to display the patron's request for service. The method provides a simple means to immediately, remotely, and specifically identify a restaurant patron's varied requirements of a waiter.

### BRIEF DESCRIPTION OF THE DRAWINGS

The drawing shows an isometric view of the tabletop stand having a base with rotatably affixed signs.

### DETAILED DESCRIPTION OF THE INVENTION

The apparatus is a restaurant tabletop stand. It is a means for silent communication between a restaurant patron and a waiter to identify a specific need of the patron that matches a specific duty of the waiter. In the preferred embodiment, one stand is located atop each table in a restaurant.

In alternative embodiments, the stand is located adjacent to each restaurant table or is mounted on a wall next to each table. For these embodiments, a means for mounting said stand adjacent to a restaurant table is used. Such means are supports, brackets, shelves or other well-known attachment or support means.

In the preferred embodiment shown in the drawing, the stand is approximately 6 inches on all sides, but may be any convenient size to fit in the restaurant environment. The stand contains a plurality of signs with numbers (30), which are rotatably mounted on the base unit (10) to either lie approximately horizontally or stand approximately vertically. In the preferred embodiment, a hinge (20) provides the means to mount and rotate a sign.

The signs must show a number when flipped-up to approximately a vertical position. In the preferred embodiment, the same number is printed on both sides of a sign to be easily read by the patron when the sign is in either the horizontal or vertical position. In an alternative embodiment, the side observable when the sign is in a horizontal position may be a description of the service required or a simple picture decal of that service requirement, such as a coffee cup, a filled water glass, a bill, a beer stein, a wine bottle, a waiter, a menu, water, etc.

In the preferred embodiment, the base unit (10) holds a label (40) to correspond with each numbered sign to identify the service request corresponding to the number on the sign. The label may be removeably attached to the base to allow restaurant management to change the designations from time to time.

In an alternative embodiment, the invention includes learning flash cards for waiter training, extra numbers and a variety of labels to describe alternate services corresponding to a number.

In the method of the invention, a restaurant patron reads the labels (40) to determine which number, or numbers, corresponds to the patron's specific service requirement and then rotates the sign with that number to a vertical position. As shown in the drawing, more than one sign may be rotated to a vertical position to indicate more than one request.

It is an object of the invention to utilize a simple number system to allow a restaurant patron a silent, discrete and immediate means to convey a request for a specific service. The number system must be simple to permit patrons to easily understand and use the system. Having a silent system capable of conveying patron requirement eliminates distracting activities and enhances the dining experience in the restaurant. A discrete system maximizes the ability of a patron to convey his requirements with a minimum of distraction for the other patrons. An immediate means of conveying a patron's requirements eliminates any need for the patron to wait to express his requirement for service.

The invention incorporates a number system that permits the patron to have a more enjoyable visit to the restaurant and concentrate on events other than those needed to attract the attention of a waiter or restaurant management, respond to unnecessary interruptions by a waiter, or deal with distractions from wait staff traffic in the aisles. The numbers directly correspond to requests commonly experienced in the restaurant and are identified by labels on the stand corresponding to a particular number on the stand. In the preferred embodiment, the labels are pre-printed in attractive fonts and extra labels are made available for management to change the designation as appropriate. In an alternative embodiment, the labels are simple handwritten explanations that may be erased and easily redesignated by management.

It is an object of the invention to promote restaurant efficiency in several ways: First, the invention improves efficiency by identifying a specific service requirement, which enables a waiter to avoid extra trips back and forth from the patron to the kitchen or cashier, or to the patron to inquire as to any needs. Second, the invention improves efficiency by enabling a waiter to immediately identify multiple restaurant patrons who require the same service, such as coffee, a menu, drinks, a waiter, a final bill, etc. Third, the invention improves efficiency by notifying management of unmet service needs and allowing management to monitor patron waiting time, thus determining waiter attentiveness, or directing other wait staff to respond to outstanding requests. Waiter awareness that this ongoing performance evaluation also motivates the waiter to be more attentive.

By promoting efficiency in the movements of a waiter and in monitoring waiter response time, the restaurant management better serves its patrons and avoids hiring unneeded wait staff. A more efficient waiter also promotes a more pleasant dining experience for the patron, which is good for future business. Greater efficiency in turn lowers restaurant costs and improves profitability. Finally, the invention promotes contact between a waiter and patron when such contact is required by the patron, permitting avoidance of unwanted interruptions by the waiter and promoting patron contact initiated by the patron.

While there has been described herein what is considered to be the preferred exemplary embodiments of the present invention, other modifications of the present invention shall be apparent to those skilled in the art from the teachings herein, and it is therefore, desired to be secured in the appended claim all such modifications as fall the true spirit and scope of the invention. Accordingly, what is desired to be secured by Letters Patent of the United States the invention as defined and differentiated in the following claims in which

What is claimed is:

1. A restaurant tabletop stand comprising,
(a) a base unit;
(b) a plurality of signs each printed with a number and rotatably attached to the base unit such that said signs may manually positioned to lie approximately horizontally or vertically and when positioned vertically to display said number; and,
(c) a label corresponding to each said sign indicating a specific restaurant patron service requirement.

2. The restaurant tabletop stand of claim 1 wherein the base unit is approximately six inches in each dimension.

3. The restaurant tabletop stand of claim 1 further comprising, a means for mounting said stand adjacent to a restaurant table.

4. The restaurant tabletop stand of claim 1 further comprising a hinge connecting each said sign to said base unit.

5. The restaurant tabletop stand of claim 1 wherein said signs contain a number on the side visible when said sign is positioned approximately horizontally.

6. The restaurant tabletop stand of claim 1 wherein said signs contain a picture decal of a service requirement on the side visible when said sign is positioned approximately horizontally.

7. The restaurant tabletop stand of claim 1 further comprising, flash cards for the waiter training.

8. The restaurant tabletop stand of claim 1 further comprising, a variety of labels to describe the alternative services corresponding to a number.

9. The restaurant tabletop stand of claim 1 wherein said labels are capable of being written upon, erased and re-written upon a plurality of times.

10. A method of using the restaurant tabletop stand of claim 1 comprising,
(a) reading the labels to determine which number corresponds to a service requirement;
(b) selecting the sign with the number corresponding to a requested service requirement; and,
(c) rotating the selected sign to a vertical position.
